(19) United States
(12) Patent Application Publication
(10) Pub. No.: US 2010/0126743 A1
(43) Pub. Date: May 27, 2010

(54) IMPLEMENT FRAME WITH FRONT FOLDING WINGS AND TRANSPORT WHEELS

(75) Inventors: Gerald W. Poole, Plainfield, IL (US); Paul Paluch, Woodridge, IL (US)

Correspondence Address: CNH America LLC;Intellectual Property Law Department, 700 STATE STREET, RACINE, WI, 53404, US

(73) Assignee: CNH America LLC, New Holland, PA (US)

(21) Appl. No.: 12/276,213

(22) Filed: Nov. 21, 2008

(51) Int. Cl. A01B 49/06

(52) U.S. Cl. 172/311; 172/191

(57) ABSTRACT

An agricultural implement arrangement is disclosed that may provide wheel assemblies that are stored in front of wing assemblies and row units mounted thereon. The arrangement may include actuators to extend the wheel assemblies in order to lift the row units off the ground to move to a transport position. When in a fully-folded position, the wing wheel assemblies may interleave. The arrangement may also shift the weight of the wing assemblies while in transport position to the hitch of the tractor and center the rearward weight over the central wheel assembly.

### BACKGROUND

The present invention relates generally to the field of agricultural implements, such as planters and other wide, foldable implements towed behind a work vehicle, such as a tractor.

A wide range of farm implements have been developed and are presently in use for tilling, planting, harvesting, and so forth. Seeders or planters, for example, are commonly towed behind tractors and may cover wide swaths of ground which may be tilled or untilled. Such devices typically open the soil, dispense seeds in the opening, and reclose the soil in a single operation. Seeds are commonly dispensed from seed tanks and distributed to row units by a distribution system. To make the seeding operation as efficient as possible, very wide swaths may be covered by extending wings on either side of a central section of the implement pulled by the tractor. Included in the wing assemblies are tool bars, row units mounted thereon, and support wheels. The wings and row units are commonly disposed in a “floating” arrangement during the planting operation, wherein hydraulic cylinders allow the implement to contact the soil with sufficient force to open the soil, dispense the seeds and close the soil. For transport, the wings may be elevated by the support wheels to disengage the row units from the ground and folded forward to reduce the width of the implement.

The central section of the implement may also contain support wheels that are extended when in a transport position. For wide implements incorporating a central section, wings, and row units of the type described above, the support wheels add complexity to the assembly and limit the available configurations of row units. In particular, when in a planting position, portions of the support wheels, the related actuators, and assemblies are positioned between the row units.

### BRIEF DESCRIPTION

Embodiments of the invention provide an innovative arrangement for transporting agricultural implements, particularly for transitioning from a planting to a transport position. The present embodiments may be used in a wide range of settings, but are particularly well-suited for implements such as seeders, planters, discs, plows, and so forth in which winged extensions can be folded forward by mechanisms after the wings and attached row units are raised from contact with the ground. For example, the present embodiments may provide wheel assemblies that are stored in front of the row units so as not to affect crop row spacing. The arrangement may then provide for actuators to extend the wheel assemblies in order to lift the row units off the ground to move to a transport position. When in a fully-folded position, the wing and wheel assemblies may be arranged to interleave, in order to minimize width of the implement in transport position. The arrangement may also provide improved stability and load balancing by shifting the weight of the implement while in transport position.

### DRAWINGS

These and other features, aspects, and advantages of the present invention will become better understood when the following detailed description is read with reference to the accompanying drawings in which like characters represent like parts throughout the drawings, wherein:

FIG. 1 is a perspective views of an embodiment of an agricultural implement, e.g., a planter, in a planting position, wherein the implement includes a central portion and wing assemblies that can be folded forward to a transport position;

FIG. 2 is a perspective view of an embodiment of the agricultural implement in a transport position, illustrating the wing assemblies in a folded forward position;

FIG. 3 is a top view of an embodiment of the agricultural implement in a planting position;

FIG. 4 is a bottom view of an embodiment of the agricultural implement in a transport position;

FIG. 5 is a rear view of an embodiment of the planter implement in a transport position; and

FIG. 6 is a side view of an embodiment of the agricultural implement in a transport position, illustrating the central wheel assembly in an extended position.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

As discussed in detail below, various configurations of agricultural implement systems may be employed to improve control over implements during transport and to increase flexibility during seeding. In particular, when in a planting or ground engaging position, portions of wing support wheels, related actuators, and assemblies are positioned between the wing row units. This arrangement affects and increases the minimum spacing between row units, thereby increasing the overall planter width and limiting crop row spacing for operators. Moreover, when the wings are folded forward in a transport position, the weight of the implement may be shifted as wheels are extended, placing an unbalanced load on the tractor hitch and causing stress on the folding mechanism. For example, the embodiments discussed below may employ a support wheel assembly on each wing to be positioned in front of the tool bar when retracted while the row units are engaged in the ground. Further, a central wheel assembly may be stored in front of a central tool bar and may be deployed, raising the implement system when the wings are folded forward, thereby increasing clearance during transport. In an embodiment, the wings may fold forward, where the wings will couple or lock to a tow bar, the wing wheel assembly may then be retracted, thereby interleaving the wing support wheels and improving weight distribution during transport.

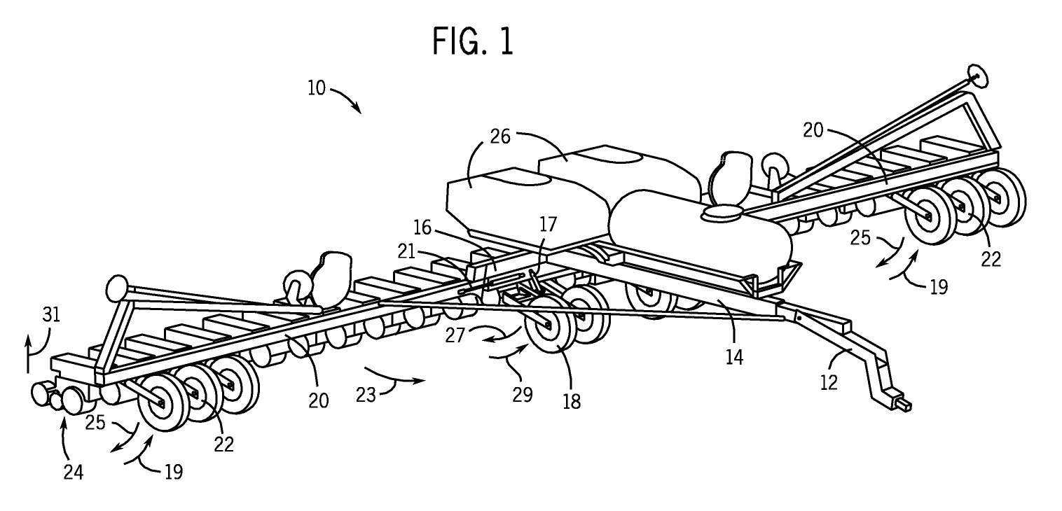

Turning now to the drawings and referring first to FIG. 1, an agricultural implement 10 is illustrated in the form of a planter. The implement is designed to be towed behind a work vehicle such as a tractor. The implement includes planter hitch assembly 12 which is attached to tow bar 14. Planter hitch assembly 12 may be used to attach planter 10 to a tractor and may be pivotally coupled to tow bar 14 to allow flexibility as the planter implement changes elevation as it is towed across a terrain. Also included in planter 10 is central tool bar 16. Central tool bar 16 extends transversely with respect to the tow bar 14. Central wheel assembly 18 is disposed below and coupled to central tool bar 16. Central wheel assembly 18 may include an actuator 17 that extends the assembly to a transport position. Further, central wheel assembly 18 may also be retracted when the planter is in a planting or ground engaging position.

Wing tool bars 20 are disposed on each side of central tool bar 16. Wing tool bars 20 are pivotally coupled to central tool bar 16 enabling wing tool bars 20 to fold in a forward direction 23 when the planter 10 is in a compacted transport position. When in transport position, wing tool bars 20 are generally parallel to central tool bar 16. Wing wheel assemblies 22 are used to lift tool bars 20, thereby enabling planter 10 to move to a transport position. Wing wheel assemblies 22 may be retracted in a direction 19 or extended in an opposite direction 25 to move the wing tool bars from the ground engaging position to the transport position, respectively. As the wing wheel assemblies 22 are extended in direction 25, row units 24 are elevated above contact with the ground, thereby removing the planter 10 from the planter position. Actuators 21, such as hydraulic cylinders, may be attached to tow bar 14 and/or central tool bar 16 and each wing tool bar 20 to facilitate the folding of wing tool bars 20. One or more wing actuators 21 may be attached to each of the two wing tool bars 20 in order to control the wings. The wing actuators 21 may be connected on each end, to the tow bar 14 and/or central tool bar 16 and each wing tool bar 20, by pins or other pivoting joint.

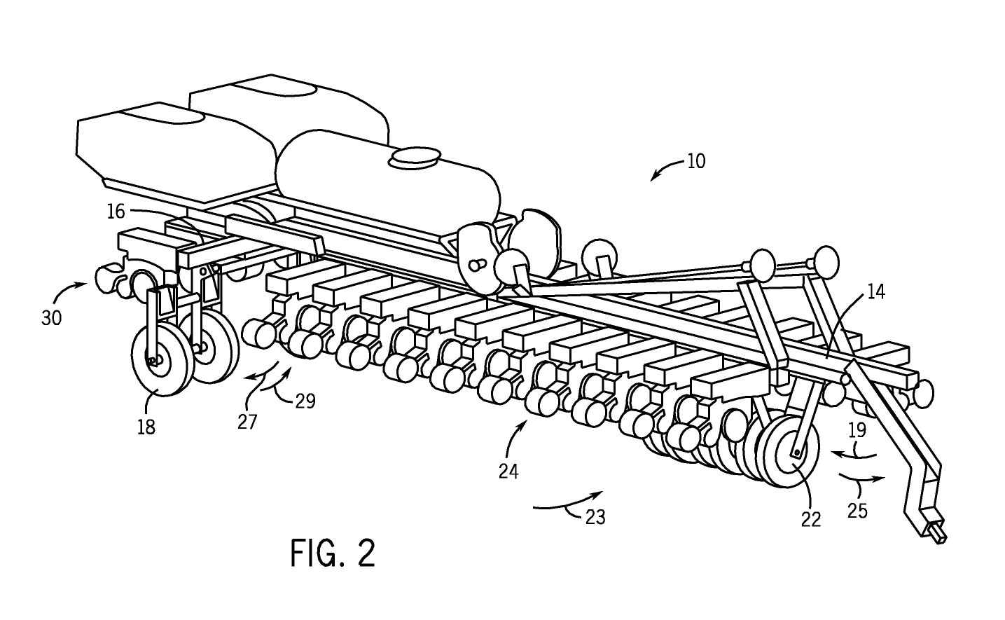

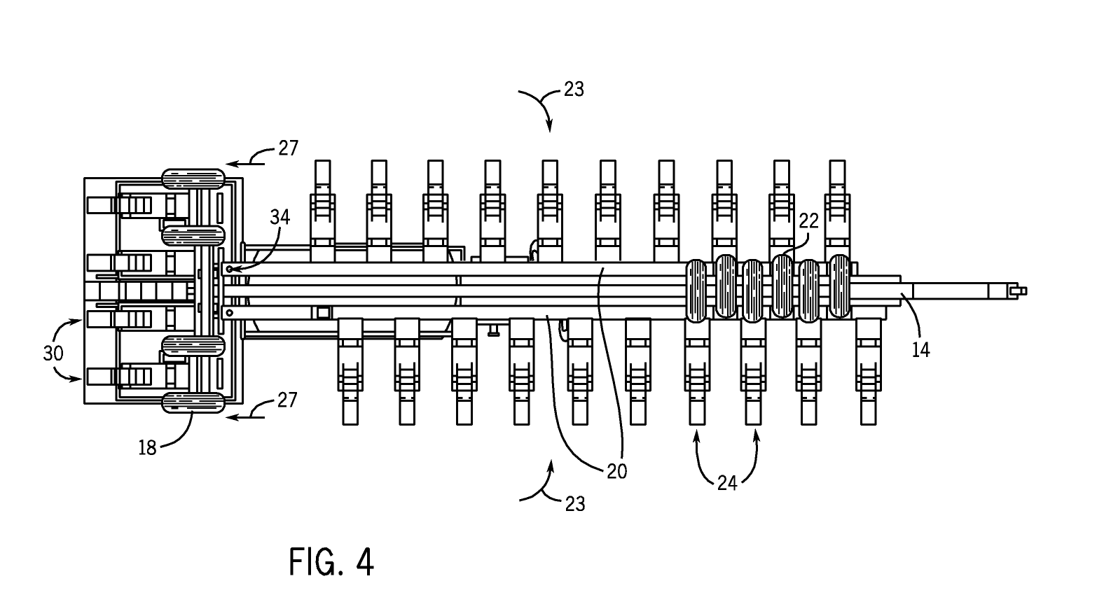

In an embodiment, wing wheel assemblies 22 may be extended while wing tool bars 20 are folded forward toward tow bar 14. When the wing tool bars 20 are fully folded, they may be elevated over tow bar 14. Wing wheel assemblies 22 may then be retracted, enabling the wing tool bars 20 to lock to tow bar 14, and enabling the wheels to interleave, thereby reducing the overall width of the planter 10 when in a compacted transport position. As wing wheel assemblies 22 are retracted, central wheel assembly 18 may be extended in direction 27, to elevate the implement 10 in transport mode. As discussed below, when interleaved, the wing wheel assemblies 22 include at least one opposing tool bar wheel adjacent to that wing's wheel. This position is referred to as the compacted transport position. The wheel assemblies 22 from opposite sides face one another in staggered positions as the tool bars 20 fold toward one another, as shown by arrow 23. Eventually the wheel assemblies 22 are at least partially or entirely overlapping in a row, parallel to the tow bar 14, where the wheel assemblies 22 alternate from the left bar 20 to the right bar 20 (See FIGS. 2 and 4).

Also attached to wing tool bars 20 are wing row units 24. Wing tool bars 20 support the row units 24 designed to dispense seeds along parallel rows and at a desired spacing in a field. Depending upon the design of the row units and upon such factors as the nature of the field (e.g., tilled or untilled), each row unit may serve a variety of functions and may have structures designed for these functions. Such structures may include, for example, an opening disc, a metering system, a covering disc, a firming wheel, a fertilizer dispenser, and so forth. Recipients or hoppers may be mounted on the framework of each row unit for receiving seeds, fertilizer or other materials to be dispensed by the row units. In the present embodiment, a distribution system serves to communicate seeds from the seed tanks to the various row units.

When wing wheel assemblies 22 are extended in a downward and rearward direction 25 to a deployed or extended position, wing row units 24 are lifted so as not to be in contact with the ground below. Moreover, central wheel assembly 18 may be extended 27 in the same manner, downward and rearward, away from the tractor, to an extended position, further lifting row units 24. Wing tool bars 20 may be folded forward 23 while wing row units 24 are elevated, enabling wing tool bars 20 to fold inward toward tow bar 14.

When wing tool bars 20 are folded completely forward 23, wing wheel assemblies 22 may be raised 19 and retracted 25 in order to enable wing tool bars 20 to be secured to tow bar 14 or hitch assembly 12, thereby relieving the load sustained by the wing actuators 21. For example, wing wheel assemblies 22 may raise the wings high enough to allow the wings to be above the planter hitch assembly 12 when fully folded, and then lower the assemblies onto and lock or couple to the hitch assembly 12. In the embodiment, central wheel assembly 18 may be fully extended 27 to the deployed or transport position, lifting wing wheel assemblies 22 out of ground contact when the wing tool bars 20 are completely folded forward, shown by arrow 23. As central wheel assembly 18 is extended, the placement of seed tanks 26 on the implement 10 is used to improve stability of the implement, thereby increasing mobility. For instance, when the central wheel assembly 18 is extended, the load of seed tanks 26 may be shifted rearward from planter hitch assembly 12, further reducing the load and stress on the hitch assembly 12. This shifting of the seed tanks 26 rearward may be accomplished by any suitable mechanism, such as a hydraulics assembly. The position of central wheel assembly 18 beneath seed tanks 26 may increase stability of the implement 10 during transport.

In a folded and compacted transport position, the individual wheels of wheel assemblies 22 may interleave (see FIGS. 2 and 4), thereby reducing the overall transport width of planter 10. In the present embodiment, central wheel assembly 18 may be extended from central tool bar 16 in an arc motion rearward and downward, shown by arrow 27, to a transport position. The arc motion 27 is caused by a pivotal attachment of the wheel assemblies 18 to the central tool bar 16. For instance, central wheel assembly 18 is pivotally mounted to central tool bar 16, and therefore it moves in an arc motion when it is deployed or retracted in directions 27 and 29, respectively. Also supported by tow bar 14 and central tool bar 16, are seed tanks 26 and other planter apparatus such as a liquid fertilizer container.

A perspective view of an embodiment of the compacted transport position of agricultural planter implement 10 is depicted in FIG. 2. Included in planter implement 10 are tow bar 14, wing wheel assemblies 22, wing row units 24, and central wheel assembly 18. The figure also shows central row units 30 which are attached to central tool bar 16. When in transport position, central wheel assembly 18 is extended and central row units 30 are elevated out of contact with the ground below, increasing clearance of the implement.

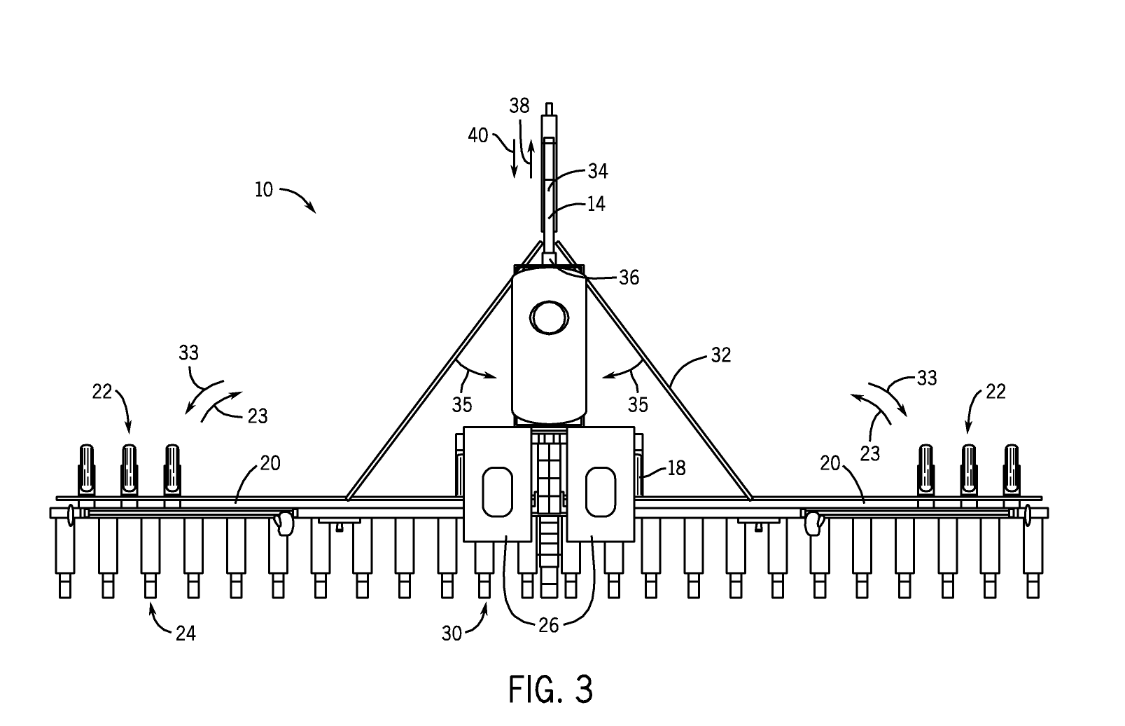

FIG. 3 shows a top view of an embodiment of planter implement 10 in the ground engaging position. Draft tubes 32 are shown, which are connected to tow bar 14, as well as each of wing tool bars 20. In the embodiment, wing tool bars 20 fold forward in a direction 23, draft tubes 32 collapse inward, shown by arrow 35, toward tow bar 14 due to the fact that draft tubes 32 are mounted to a telescoping portion 34 of tow bar 14. The telescoping portion 34 of tow bar 14 is utilized to extend tow bar 14 when transitioning to a fully-folded or compacted transport position, shown by arrow 38. That is, as the wing assemblies 20 are folded forward, in direction 23, the upper portion of draft tubes 32 and telescoping portion 34 move in direction 38, away from outer portion 36, drawing the draft tubes inward, indicated by arrow 35. The telescoping extension of tow bar 14 provides clearance for the wing components that come together when the planter 10 is in a transport position. Further, the telescoping portion of the tow bar 14 retracts to allow for reduced overall implement length when the wing tool bars 20 are extended and the planter is in a ground engaging position, improving maneuverability. Also illustrated are wing row units 24 mounted behind wing tool bars 20. When wing row units 24 are in a ground engaging position, wing wheel assemblies 22 are forward of wing tool bars 20. This arrangement for wing wheel assemblies 22 improves the flexibility in placement of the row units on the tool bars. For example, because wing wheel assemblies are not retracted between the row units, the spacing between wing row units 24 may be reduced, thereby increasing the density of seeding in a field. Central row units 30 are also mounted behind central tool bar 16, which supports seed tanks 26. In the embodiment, there are four central row units 30 and ten wing row units 24 located on each of the wing tool bars 20. The number and configuration of row units 24 may vary depending on application, cost, and physical factors. Both sets of row units 24 and 26 may be raised from contact with the ground when the central wheel assembly 18 and/or wing wheel assemblies 22 are extended, shown by 27 and 25, respectively.

An embodiment of the planter implement 10 is shown in a transport position in FIG. 4. This view shows planter implement 10 from the bottom in the fully-folded or compacted transport position. In a presently contemplated embodiment shown, wing wheel assemblies 22 from opposite sides (e.g., left and right) are in an interleaved arrangement 39 below tow bar 14 when wing tool bars 20 are folded forward 23. The interleaved wing wheel assemblies 22 includes at least one opposing tool bar wheel adjacent to that wing's wheel. For example, when completely folded, the figure shows that the wheels alternate from front to back in the following fashion: left wing wheel, right wing wheel, left wing wheel, right wing wheel, left wing wheel, right wing wheel.

Central wheel assembly 18 is shown in an extended position forward of central tool bar 16 and below seed tanks 26. Wing pivots 34 are located on wing tool bars 20, pivotally coupling each tool bar 20 to central tool bar 16. Wing pivots 34 enable wing tool bars 20 to fold forward 23 and rearward 33 into a ground engaging position. As discussed above, when in a fully-folded transport position, wing tool bars 20 may lock to tow bar 14 by hooks, latches, or other fasteners, thereby shifting the weight of wing tool bars 20 to the planter hitch assembly 12 and the attached tractor. This arrangement relieves stress and reduces the load on the folding mechanisms, actuators 21, and the pivot points 34 by coupling the outer portions of wing tool bars 20 to the tow bar 14.

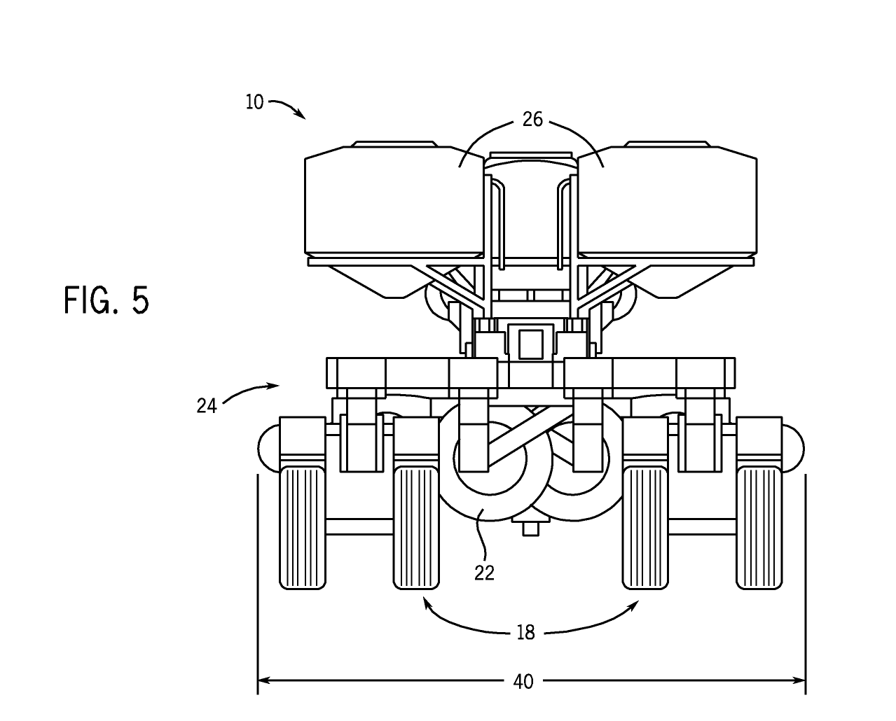

FIG. 5 illustrates an embodiment planter implement 10 in a compacted transport position from a rear view. The figure includes wing row units 24 as well as wing wheel assemblies 22. Central wheel assembly 18 is extended 27 and supports the weight of seed tanks 26, which are located above and behind central wheel assembly 18. In the extended position, the load of seed tanks 26 may be shifted rearward from planter hitch assembly 12, further reducing the load and stress on the hitch assembly 12. This shifting of the seed tanks 26 rearward may be accomplished by any suitable mechanism, such as a hydraulics assembly. The position of central wheel assembly 18 beneath seed tanks 26 may increase stability of the implement 10 during transport. As illustrated, implement width 36 is minimized due to the interleaving arrangement of wing wheel assemblies 22 as previously discussed.

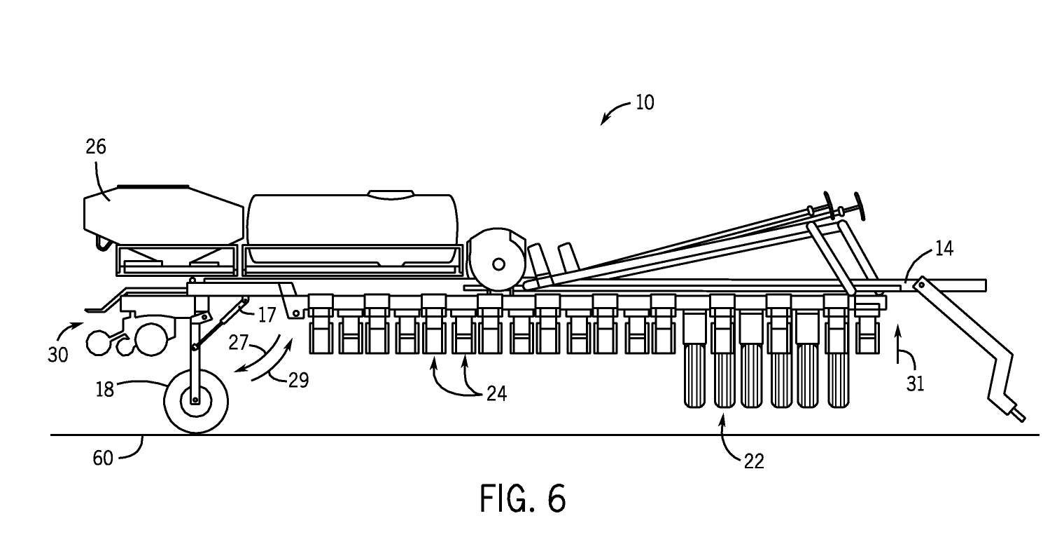

FIG. 6 shows an embodiment of a side view of planter implement 10 in a folded transport position. In the illustrated position, central wheel assembly 18 is in a fully-extended or deployed position, thereby lifting wing wheel assemblies 22, wing row units 24, and central row units 30 off the ground 60. Central wheel assembly 18 may be extended by an actuator 17.

Wing tool bars 20 may include joints and/or linkages as well as actuators to enable row units 24 to adjust to the contours of a field. As shown previously in FIG. 3, the positioning of wing wheel assemblies 22 and central wheel assembly 18 forward of the tool bars 20 when the assemblies 22 are retracted 19 and the planter is in a planting or ground engaging position, reduces the spacing between row units 24 and 30, enabling an operator to further reduce the width between rows planted. Further, this arrangement provides more efficient use of tool bar space on the implement, maximizing the amount of rows to be planted in each pass across a field. The wheel arrangement may also improve stability, especially during transport by moving the seed tank load away from the hitch assembly, while reducing the folded width of the implement.

A number of variations may be envisaged for the arrangement described above. For example, a pair of tension members may be used to control the movement of central wheel assembly 18, with one being fitted on either side of the actuator to provide redundancy. Similarly, the tension member may be designed for removal from the arrangement, as in the illustrated embodiment, or may remain resident with the implement. In the latter case, the tension member may be hooked or otherwise configured to be swung down on one or more pins by pivotal movement on one of the pins, or on an additional structure. Moreover, in alternative configurations, the tension member may be secured to other components of the tool bar, brackets, or other elements than the pins used to secure the actuator pivotally to the implement.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A towable agricultural implement comprising:
a tow bar assembly to be towed in operation coupled to a transverse central tool bar;
two wing tool bars, pivotally coupled to the central tool bar, configured to fold forward and lock to a planter hitch assembly which is coupled to the tow bar assembly;
a plurality of wing actuators, coupled to the tow bar assembly and coupled to each of the two wing bars, wherein the wing actuators are controllable to extend and fold the wing tool bars;
a plurality of row units attached to the central tool bar and the wing tool bars;
a plurality of wing wheel assemblies coupled to the wing tool bars, wherein the wing wheel assemblies are configured to retract forward of the wing tool bars when the implement is in a ground engaging position and to extend toward the row units and below the wing tool bars in a first extended position;
a central wheel assembly coupled to the tow bar assembly, wherein the central wheel assembly is configured to retract to a position forward of the central tool bar when the implement is in a ground engaging position and to extend toward the row units and below the central tool bar in a second extended position; and
a seed tank assembly supported by the tow bar assembly and configured to shift relative to the tow bar assembly to redistribute a load of the seed tank assembly.

2. The implement of claim 1, wherein the central wheel assembly comprises a plurality of central wheels and an actuator configured to move the central wheels in downward arc motion, to the second extended position.

3. The implement of claim 1, wherein the wing wheel assemblies each comprise a wing wheel configured to move in a downward and rearward motion, toward the row units.

4. (canceled)

5. The implement of claim 3, wherein the ground engaging position of the implement comprises a configuration where the wing wheels are out of contact with a ground region and the plurality of row units are in contact with the ground region.

6. The implement of claim 3, wherein the wing wheels are configured to be opposite the wing row units on each wing tool bar and generally centered on an axis running in the direction the implement is towed, when the wing tool bars are folded forward and locked.

7. The implement of claim 1, wherein the wing actuators are hydraulic cylinders.

8. The implement of claim 1, wherein the wing wheels are in an interleaved position when the wing tool bars are folded forward and locked.

9. The implement of claim 1, wherein the tow bar assembly is comprises a telescopic assembly.

10. A towed agricultural implement comprising:
a central frame configured to be towed in operation, the frame including a hitch assembly and a transverse tool bar, wherein the frame supports a plurality of row units attached to the tool bar;
a pair of wing tool bars, each pivotally coupled to the central frame and supporting a plurality of row units, wherein each wing tool bar is configured to fold forward and lock to the hitch assembly;
a plurality of wing actuators coupled to the central frame and to each of the two wing tool bars, wherein the wing actuators are controllable to extend and fold the wing tool bars;
a plurality of wing wheel assemblies coupled to the wing tool bars, wherein the wing wheel assemblies are configured to enable a range of motion from forward of the wing tool bars, extending downward under the wing tool bars in order to raise the row units from a terrain;
a central wheel assembly coupled to the central frame, configured to allow a range of motion from a position forward of the transverse tool bar, extending downward and rearward, in an arc motion, in order to raise the row units from the terrain; and
a seed tank assembly supported by the central frame and configured to shift relative to the central frame to redistribute a load of the seed tank assembly.

11. The implement of claim 10, wherein the central wheel assembly comprises a plurality of central wheels and an actuator configured to move the central wheels in a rearward and downward motion to a first extended position.

12. The implement of claim 10, wherein the wing wheel assemblies each comprise a wing wheel configured to move from a ground engaging position to a second extended position.

13. (canceled)

14. The implement of claim 12, wherein the ground engaging position of the implement comprises a configuration where the wing wheels are out of contact with the terrain and the plurality of row units are in contact with the terrain.

15. The implement of claim 12, wherein the wing wheels are configured to be opposite the wing row units on each wing tool bar and generally centered on an axis running in the direction the implement is towed, when the wing tool bars are folded forward and locked.

16. The implement of claim 10, wherein the wing actuators comprise hydraulic cylinders coupled to the tow bar assembly and to the wing tool bars.

17. The implement of claim 10, wherein the plurality of wing wheels are in an interleaved position when the tool bars are folded forward and locked.

18. The implement of claim 10, wherein the central frame comprises a telescopic tow bar.

19. (canceled)

20. An agricultural implement system comprising:
a central frame including a hitch assembly, a tow bar, and a transverse tool bar supporting a plurality of central row units;
a central wheel assembly having a plurality of members forming joints configured to extend and retract in a arcuate motion relative to the central frame;
a pair of wing tool bars, each pivotally coupled to the central frame and supporting a plurality of wing row units, wherein each wing tool bar is configured to fold forward and couple to the hitch assembly;
a plurality of wing actuators coupled to the central frame and to each of the two wing tool bars, wherein the wing actuators are controllable to extend and fold the wing tool bars; and
a plurality of wing wheel assemblies coupled to the wing tool bars, wherein the wing wheel assemblies are configured to enable a range of motion from forward of the wing tool bars, extending downward under the wing tool bars to raise the row units from the terrain, wherein a spacing between wing row units is not constrained by the coupling of the wing wheel assemblies to the wing tool bars, wherein the plurality of wing wheel assemblies include wing wheels that are in an interleaved position when the wing tool bars are folded forward and locked; wherein the plurality of members forming the joints comprises:
a first member having a first end coupled to a wheel; and
a second member having a first end pivotally coupled to a second end of the first member, and a second end pivotally coupled to the frame.
